(19) United States
(12) Patent Application Publication
(10) Pub. No.: US 2008/0205095 A1
(43) Pub. Date: Aug. 28, 2008

(54) Ripple compensator and switching converter having such a ripple compensator

(75) Inventors: Vincent Pinon, Grenoble (FR); Pascale Robert, Lumbin (FR); Vlad Grigore, Espoo (FI)

Correspondence Address: DOCKET CLERK, P.O. DRAWER 800889, DALLAS, TX, 75380, US

(73) Assignees: STMicroelectronics SA, Montrouge (FR); Nokia Corporation, Espoo (FI)

(21) Appl. No.: 12/070,837

(22) Filed: Feb. 21, 2008

(30) Foreign Application Priority Data
Feb. 22, 2007 (EP) 07 300 808.8

(51) Int. Cl. H02J 1/02

(52) U.S. Cl. 363/39

(57) ABSTRACT

Systems and methods for compensating ripple current and improved ripple compensators and switching converters capable of compensating ripple current. In one embodiment, the ripple compensator for a switching converter of the type includes a switching means and filtering means comprises means for injecting a compensating current such that the AC component of the switching current and the compensating current are in opposite phase. In addition, the compensation current is elaborated from a signal at a node between the switching means and the filtering means.

### CROSS-REFERENCE TO RELATED APPLICATIONS

The present application is related to European Patent Application No. 07300808.8, filed Feb. 22, 2007, entitled “RIPPLE COMPENSATOR AND SWITCHING CONVERTER COMPRISING SUCH A RIPPLE COMPENSATOR”. European Patent Application No. 07300808.8 is assigned to the assignee of the present application and is hereby incorporated by reference into the present disclosure as if fully set forth herein. The present application hereby claims priority under 35 U.S.C. §119(a) to European Patent Application No. 07300808.8.

### TECHNICAL FIELD

The present disclosure relates to switching converters, and, in particular, to DC-DC switching converters. More specifically, the present disclosure relates to an improvement to such DC-DC switching converters intended to reduce or eliminate a switching ripple generated in the output voltage.

### BACKGROUND

Conventional DC-DC switching converters are usually used in power supplies for generating an output supply voltage in many electronic circuits and systems, due in particular to their high power efficiency. Another useful application for such DC-DC switching converters is directed to RF transmitters, where they are used to control the supply voltage of a radio frequency power amplifier.

DC-DC switching converters are very power efficient because their operating principle relies on power switches that are either ON or OFF such that the theoretical efficiency is of 100%. However, the DC-DC switching converters are based on the use of power switches controlled by Pulse Width Modulation (PWM) associated with an output LC filter used to generate an output voltage corresponding substantially to the DC component of the voltage delivered by the power switches.

However, it has been noticed that the switching action of conventional power switches generates a ripple in the output voltage of the converter. This output voltage ripple is responsible for unwanted spurious in many applications. For example, this is due to the switching of the current flowing into a self of the output filter of the converter.

The switching ripple must be kept below a certain limit that is dependant on the application (e.g. max. 20 mV). In order to do so, the corner frequency F_{c} of the LC output filter must be low enough when compared to the switching frequency Fs of the switching current. In practice, this corresponds in general to physically large inductor and capacitor. Even for state-of-the-art switching frequency of several MHz, their values are too big to be integrated.

Besides, in some applications, it is necessary to ramp up or down the output voltage from or to zero in a specified amount of time, (for example 30 ns). However, there is a trade-off between the dynamic response of the converter and the corner frequency F_{c} of the LC filter. The lower the corner frequency when compared to the switching frequency, the lower the switching ripple but the slower the dynamic response.

When used in a RF power amplifier, the harmonic content due to the switching ripple of the power amplifier supply voltage translates into RF spurs around the carrier in the RF spectrum at the output of the power amplifier. This is a problem, as the specification regarding RF emissions is tight, especially concerning noise in receiver band. The effect is much more pronounced in saturated power amplifiers, when compared to linear power amplifiers.

Some conventional solutions have been proposed to try to alleviate this drawback. Reference can, for example, be made to the article “Novel aspects of an application of “zero”-ripple techniques to basic converter topologies”, IEEE 1997. This conventional solution is based on the use of a specific arrangement of the coils in the output filter of the converter. However, the technology disclosed in this document is directed to a modification of the output filter circuitry.

Reference can also be made to the article “Modified switched power converter with zero ripple”, IEEE 1990. Here, ripple compensation is based on the use of an analog controlled current source which is intended to inject a current into the load which is equal and opposite to the ripple current due to the switching circuit.

More particularly, according to this technology, a feedback loop is used, which relies on the measuring of the output voltage that is applied to the load. The injected current is thus controlled in order to reduce or eliminate the difference between a desired load current and the current from the switching circuit.

However, the error should be kept as small as possible such that this technology relies on the control of a small signal that can be easily affected by noise. In addition, this technology needs to provide a large gain to generate the compensating current. At last, this technology requires a fast and precise current sense which is generally costly and difficult to lay out.

There is therefore a need for systems and methods for compensating ripple current and improved ripple compensators and switching converters capable of compensating ripple current.

### SUMMARY

The present disclosure generally provides a systems and methods for compensating ripple current and improved ripple compensators and switching converters capable of compensating ripple current.

In one embodiment, the present disclosure provides a ripple compensator for use in a switching converter. The switching converter could include a switch and a first filter. The ripple compensator could include a circuit to inject a compensating current such that the AC component of the switching current issued from the switch and the compensating current are in opposite phase. The compensating current is elaborated from a signal at a node between the switch and the first filter.

In another embodiment, the present disclosure provides a method of compensating ripple comprising injecting a compensating current for use in a switching converter having a switch and a first filter. An AC component of the switching current issued from the switch and the compensating current are could be in opposite phase. In addition, the compensating current is elaborated from a signal at a node between the switch and the first filter.

In still another embodiment, the present disclosure provides a switching converter. The switching converter could include a switch, a first filter, and a circuit to inject a compensating current such that the AC component of a switching current issued from the switch and the compensating current are in opposite phase. The compensating current is elaborated from a signal at a node between the switch and the first filter.

Other technical features may be readily apparent to one skilled in the art from the following figures, descriptions and claims.

### BRIEF DESCRIPTION OF THE DRAWINGS

For a more complete understanding of this disclosure and its features, reference is now made to the following description, taken in conjunction with the accompanying drawings, in which:

FIG. 1 illustrates schematically a conventional DC/DC switching converter;

FIG. 2 illustrates exemplary waveforms of the relevant signals of the circuit shown in FIG. 1;

FIG. 3 illustrates schematically a DC/DC switching converter provided with a ripple compensator according to one embodiment of the present disclosure;

FIG. 4 illustrates exemplary waveforms of the relevant signals of the circuit of FIG. 3;

FIG. 5 illustrates the implementation of a ripple compensator according to one embodiment of the present disclosure;

FIG. 6 is a Bode diagram of a coil current within the filtering means and of the compensating current according to one embodiment of the present disclosure;

FIG. 7 illustrates the exemplary variation of the output voltage of the DC/DC switching converter as a function of time when the ripple compensator is enabled, on the one hand, and disabled, on the other hand, according to one embodiment of the present disclosure;

FIG. 8 illustrates another embodiment of a ripple compensator according to one embodiment of the present disclosure; and

FIG. 9 illustrates exemplary waveforms of relevant signals of the embodiment shown in FIG. 8.

### DETAILED DESCRIPTION

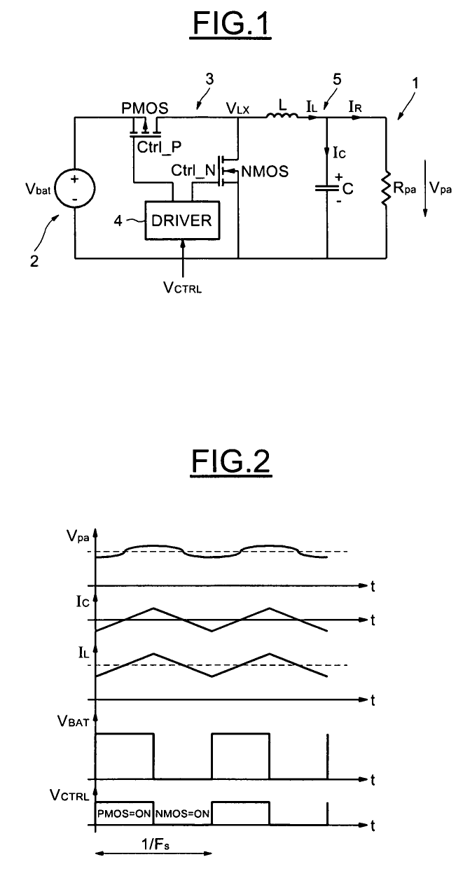

Referring to FIG. 1, a conventional DC/DC switching converter is disclosed. As illustrated, the converter, denoted by numeral reference 1, comprises a DC supply voltage source 2 consisting in a battery; switching means 3 either in an ON-state or in an OFF-state under the control of a driver 4 receiving a control signal V_{CTRL}, and filtering means constituted by a LC output filter.

For example, the object of the switching converter shown in FIG. 1 is to provide a supply voltage Vpa of high efficiency through a load resistance Rpa for an RF power amplifier. In one embodiment, the switching means could include, as disclosed, PMOS and NMOS devices controlled by Pulse Width Modulation signal Ctrl_P and Ctrl_N respectively, issued by the driver 4, and turned ON and OFF alternatively at a switching frequency Fs.

The resulting pulse width modulated voltage V_{LX} is filtered by the output LC filter, which has typically a corner frequency much lower than the switching frequency Fs of the switching means. Thus, the output voltage Vpa corresponds, as a first approximation, to the DC component of the voltage V_{LX}.

However, as previously indicated, a switching ripple, due to the switching of the current flowing into the self L, is present in the output voltage Vpa, as illustrated in FIG. 2.

It has been noticed that the magnitude of the ripples in the output voltage Vpa is given by the following relation:

$$Δ {V}_{pa} = \frac{α \cdot ( 1 - α ) {V}_{bat}}{8 \cdot L \cdot C \cdot {F}_{s}^{2}} \qquad ( Eqn . 1 )$$

In Equation 1, α is the duty cycle of the PWM, Fₛ is the switching frequency of the PWM and V_{bat} is the voltage provided by the battery 2.

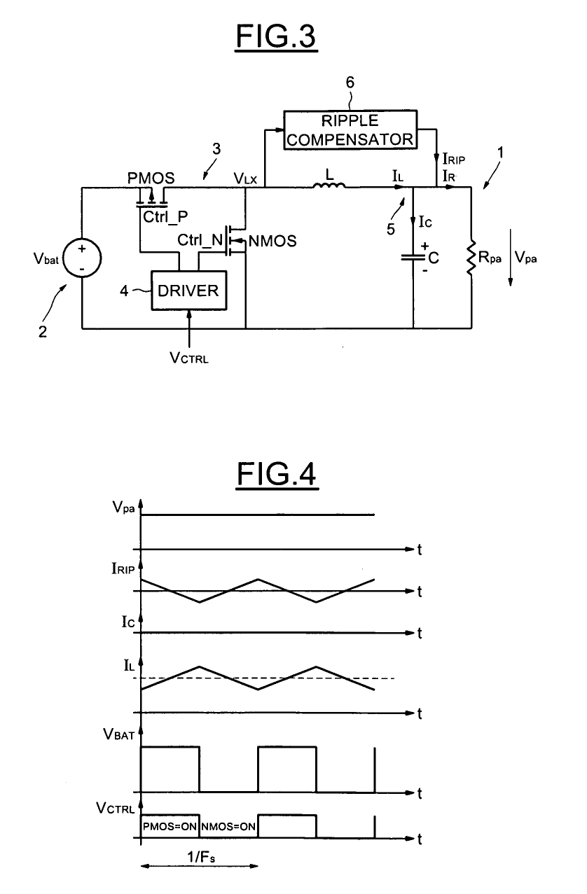

Referring to FIGS. 3 and 4, according to one embodiment of the present disclosure, the DC/DC switching converter is associated with a ripple compensator used to inject at the output of the DC/DC switching converter a compensating current i_{RIP} having a phase opposite to that of the AC component of the inductor current i_{L} generating the ripple in order to eliminate the ripple in the output voltage Vpa (see e.g., FIG. 4).

As shown in FIG. 3, the ripple compensator, denoted by numeral reference 6, is connected in parallel to the inductor L according to one embodiment of the present disclosure. In other words, the compensating current is elaborated from the output signal V_{LX} of the switching means. This voltage V_{LX} is filtered in such a way that said output is proportional to the inductor current i_{L} at the switching frequency Fₛ. The DC contribution is also filtered in order not to affect the pass band of the converter. Then, the output voltage filtered is inverted and converted into a current to be injected into the capacitor of the filtering means, after amplification.

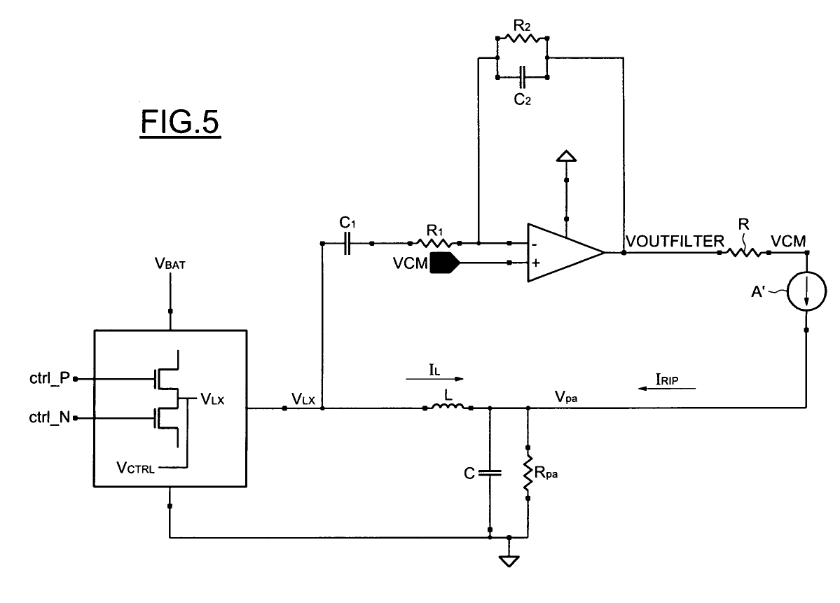

The general structure of the ripple compensator according to one embodiment of the present disclosure is illustrated in FIG. 5. This compensator essentially comprises a band pass filter. As shown in FIG. 5, this filter essentially comprises an operational amplifier A having its negative entry connected to the switching voltage V_{LX} using a resistance R1 and a capacitor C1 in series to measure the said switching voltage, a positive input receiving a control voltage V_{CM} and having its output Vₒᵤₜ connected to the negative input, by means of a filter circuitry consisting of one resistance R2 and one capacitor C2 in parallel, as shown.

It will be noted that the first resistance R1 together with the filter circuitry R2 C2 constitutes a low pass filter and an integrator part of the ripple compensator whose parameters can be determined to fit the current response of the inductor coil at the switching frequency Fₛ.

In addition, the first capacitor C1 together with the filter circuitry R2 C2 constitutes a high pass filter and the derivator part of the ripple compensator used to filter the DC component of the V_{LX} signal.

As previously indicated, the output V_{OUTFILTER} of the amplifier A is converted into current using a resistance R. It should also be noted that the switching voltage V_{LX} is entered to the negative entry of the operational amplifier A such that the output voltage of the switching means is first inverted. After conversion into current, it is then amplified using a current amplifier A′ such that the current delivered by the ripple compensator and injected into the output of the switching converter to be added to the output current of the switching means has the same magnitude than that of the ripples but with an opposite phase.

The filter transfer function of the ripple compensator is given by the following relation:

$$\frac{{V}_{OUTFILTER}}{{V}_{LX}} = \frac{- {R}_{2} \cdot {C}_{1} \cdot S}{( 1 + {R}_{1} \cdot {C}_{1} \cdot S ) ( 1 + {R}_{2} \cdot {C}_{2} \cdot S )} \qquad ( Eqn . 2 )$$

Besides, the ripple compensating current i_{RIP} as a function of the V_{LX} voltage is given by Equation 3 below:

$$\frac{{i}_{RIP}}{{V}_{LX}} = - gm \frac{{R}_{2} \cdot {C}_{1} \cdot S}{( 1 + {R}_{1} \cdot {C}_{1} \cdot S ) ( 1 + {R}_{2} \cdot {C}_{2} \cdot S )} \qquad ( Eqn . 3 )$$

In Equation 3, gm is the transconductance to convert the control signal V_{outfilter} into the active current I_{RIP}. In addition, the value of the inductor current i_{L} generating the ripple as a function of the V_{LX} voltage is given by the relationship found in Equation 4 below:

$$\frac{{i}_{L}}{{V}_{LX}} = \frac{1}{{R}_{pa}} \times \frac{1 + {R}_{pa} \cdot C \cdot S}{1 + ( L / {R}_{pa} ) \cdot S + L \cdot C \cdot {S}^{2}} \qquad ( Eqn . 4 )$$

In order to have the compensating current equal to the coil current such that the compensator constitutes a modelization of the part of the filtering means of the converter generating the ripple, the following condition must be obtained:

$$\frac{- gm}{{R}_{1} \cdot {C}_{2}} = \frac{1}{L} \qquad ( Eqn . 5 )$$

In Equation 5, gm is the conductance realized in this embodiment by the resistance R and the current amplifier A′.

In view of the foregoing, by suitably selecting the resistances R and R1 and the capacitor C2, it is possible to compensate the ripples generated by the switching of the current flowing into the self L.

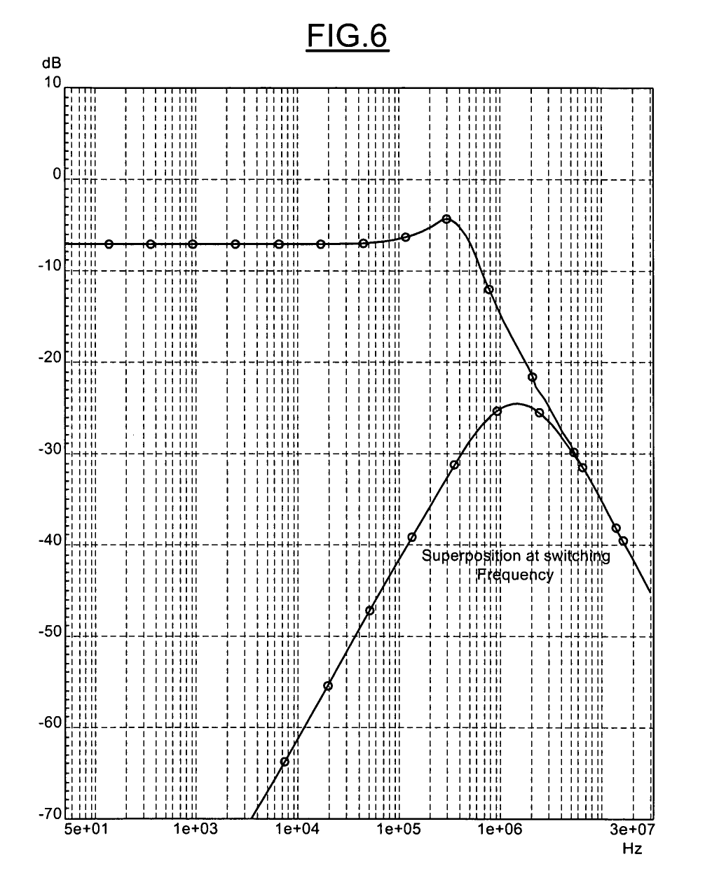

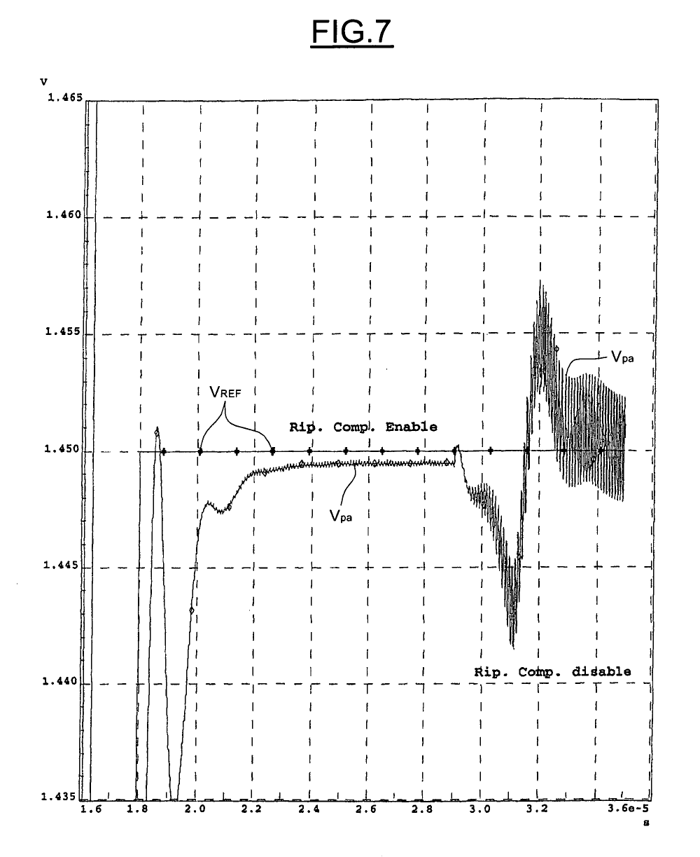

As a matter of fact, referring to FIGS. 6 and 7, illustrating respectively the inductor current i_{L} and the compensating current i_{RIP} at the switching frequency on the one hand, and the output voltage Vpa relative to the desired output voltage V_{REF}, on the other hand, the compensating current is superposed to the inductor current at the switching frequency such that, when the ripple compensator is enabled, the ripples are eliminated without affecting the DC component.

For example, for a inductor value L of 1 μH, for a maximum amplitude current the ripple compensator will have to provide of ±53 mA, for a maximum amplitude tolerated at the output of the filter of 0, 53 volt, using relationship shown by Equation 3, the transconductance gm of the system is 0, 1.

Using Equation 5, R1 is for example equal to 100 Kohm and C2 is 1 pF.

As concerns the current conversion between the output voltage filter and the input current amplifier A′, a low resistance value R will lead to a low gain but a too low resistance will affect the low input impedance of the current amplifier.

At the opposite, a too high resistance R implies a too high gain for the current amplifier A′, which is difficult to design. A compromise is chosen and the resistance value R is fixed to 1 Kohm. The gain of the current amplifier A′ is 100 to have the required transconductance gm of 0, 1.

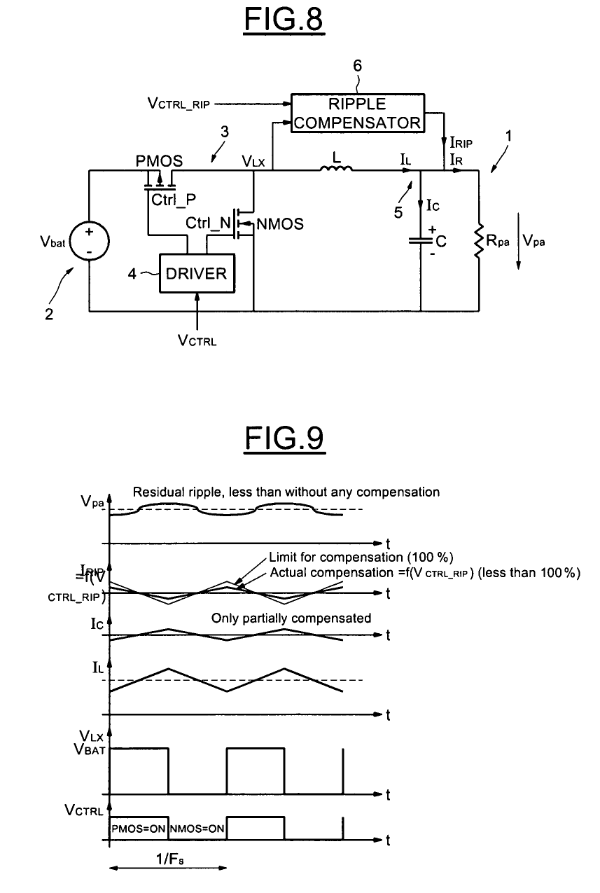

Referring to FIGS. 8 and 9, a partial ripple compensator is now disclosed. The ripple compensator has a negative impact on the overall power efficiency of the converter. The overall efficiency is, in principle, inversely proportional to the amount of ripple compensation (i.e., the better the ripple compensation, the lower the efficiency).

Consequently, according to the embodiment illustrated in FIG. 8, the ripple compensator 6′ which is in other aspects identical to that of FIGS. 3 and 5 receives, as an input, a ripple compensation voltage control V_{CTRL}_{_{—}}_{RIP} acting, for example, on the current amplifier A′ to lower, when necessary, the compensation.

For example, as generally disclosed in FIG. 9, the ripple compensation current can be thus set within a range up to an upper limit corresponding to a full compensation of the ripple.

For example, the ripple compensation can be partial all the time, the percentage of a ripple compensation being required by the application. The percentage of the ripple compensation is thus predefined, namely decided during the design phase of the system voltage supply incorporating the switching converter, based on specific requirements.

The percentage of ripple compensation can also be controlled dynamically. The voltage supply system can thus prescribe an amount of ripple compensation desired at a given moment.

At last, the ripple compensation can be made partial for calibration purposes. As a matter of fact, one problem associated with the generation of ripple compensation current is that the inductance L affects directly the amplitude of the compensating current. Power inductors may have ±20% of tolerance and this variation will affect the quality of ripple compensation.

Moreover, the switching voltage V_{LX} is not an ideal pulse width modulated signal, due to limited raise/fall time and non-zero value during the intervals when the low side switch is conducting. The additional control voltage V_{CTRL}_{_{—}}_{RIP} uses a possibility to calibrate the ripple compensation in manufacturing and/or online, if the ripple can be measured and the feedback is closed to the control voltage V_{CTRL}_{_{—}}_{RIP} to minimize the ripple.

Accordingly, embodiments of the present disclosure generally provide a ripple compensator which overcomes the drawbacks of conventional systems.

In particular, one object of the present disclosure is to provide a ripple compensator which can reduce or eliminate the ripple in an inexpensive arrangement and which can be easily integrated without needing to modify the switching converter.

Another object of the present disclosure is to provide such a ripple compensator with high dynamic features. Accordingly, one embodiment of the present disclosure proposes a ripple compensator for a switching converter of the type having switching means and filtering means.

The compensator according to the present disclosure comprises means for injecting a compensating current such that the AC component of the switching current issued from the switching means and the compensating current are in opposite phase.

In addition, according to a general feature of the present disclosure, the compensating current is elaborated from a signal at a node between the switching means and the filtering means.

The signal used to generate the compensating current is the voltage directly delivered by the switching means and therefore has a large amplitude. It can therefore be easily measured as compared with the compensators according to the state of the art using the signal issued from the filtering means.

In addition, the ripple compensator according to the present disclosure can be realized in the form of a block which can be easily added to an existing switching converter design since it only needs a connection to the output of the switching means and to the output of the filtering means to inject the compensating current.

Furthermore, on the contrary to the uncompensated switching converters which require filtering means having a large inductor L and a large capacitor C for the switching means in order to keep the value of the corner frequency of the filtering means low enough when compared to the switching frequency of the switching means, such that the inductor and the capacitor are generally too big to be integrated, according to the present disclosure, the requirements concerning the inductor and the capacitor can be relaxed such that the switching converter can be integrated on a relatively small area.

According to another feature of the present disclosure, the ripple compensator comprises measuring means for measuring the voltage at the node between the switching means and the filtering means.

According to yet another feature of the present disclosure, the compensator comprises further means for modelizing the filtering means of the switching converter generating the ripple.

According to one embodiment of the present disclosure, the means for modelizing the filtering means comprise a filter adapted to generate a compensation voltage proportional to a ripple current generated in-said filtering means.

For example, the compensator further comprises means for converting the compensation voltage into the compensating current and means for adding said compensating current and said ripple current.

It further comprises means for amplifying the compensating current.

According to another feature of the present disclosure, the compensator comprises elimination means for eliminating the DC component of the compensating current.

For example, said elimination means comprise a high-pass filter.

According to one embodiment of the present disclosure, the compensator comprises means to vary the level of compensation provided by said compensation.

According to another aspect, the present disclosure provides a switching converter of the type having switching means for generating a switched voltage and filtering means for filtering said switched voltage, characterized in that it further comprises a ripple compensator as defined above.

This switching converter constitutes, in one embodiment, a DC/DC switching converter.

It may be advantageous to set forth definitions of certain words and phrases used in this patent document. The term “couple” and its derivatives refer to any direct or indirect communication between two or more elements, whether or not those elements are in physical contact with one another. The terms “include” and “comprise,” as well as derivatives thereof, mean inclusion without limitation. The term “or” is inclusive, meaning and/or. The phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like.

While this disclosure has described certain embodiments and generally associated methods, alterations and permutations of these embodiments and methods will be apparent to those skilled in the art. Accordingly, the above description of example embodiments does not define or constrain this disclosure. Other changes, substitutions, and alterations are also possible without departing from the spirit and scope of this disclosure, as defined by the following claims.

What is claimed is:

1. For use in a switching converter having a switch and a first filter, a ripple compensator comprising:
a circuit to inject a compensating current such that the AC component of the switching current issued from the switch and the compensating current are in opposite phase,
wherein the compensating current is elaborated from a signal at a node between the switch and the first filter.

2. The ripple compensator according to claim 1 further comprising:
a second circuit to measure the voltage at said node between the switch and the first filter.

3. The ripple compensator according to claim 2 further comprising:
a third circuit to model the first filter of the switching converter generating the ripple.

4. The ripple compensator according to claim 3, wherein the third circuit comprises a second filter adapted to generate a compensation voltage proportional to a ripple current generated in the first filter.

5. The ripple compensator according to claim 4 further comprising:
a converter to convert the compensation voltage into the compensating current and an adder to add the compensation current and the ripple current.

6. The ripple compensator according to claim 5 further comprising:
an amplifier to amplify the compensating current.

7. The ripple compensator according to claim 5 further comprising:
an elimination circuit to eliminate the DC component of the compensation current.

8. The ripple compensator according to claim 7, wherein the elimination circuit comprises a high-pass filter.

9. The ripple compensator according to claim 1, wherein the ripple compensator varies the compensation provided by said compensation current.

10. The ripple compensator according to claim 1, wherein the switch generates a switched voltage and the filter is capable of filtering the switched voltage.

11. The ripple compensator according to claim 10 wherein the switching converter further comprises a DC/DC switching commutator.

12. For use in a switching converter having a switch and a first filter, a method of compensating ripple comprising injecting a compensating current,
wherein an AC component of the switching current issued from the switch and the compensating current are in opposite phase, and
wherein the compensating current is elaborated from a signal at a node between the switch and the first filter.

13. The method according to claim 12 further comprising:
measuring the voltage at said node between the switch and the first filter.

14. The method according to claim 13 further comprising:
modeling the first filter of the switching converter generating the ripple.

15. The method according to claim 14 further comprising:
generating a compensation voltage proportional to a ripple current generated in the first filter.

16. The method according to claim 15 further comprising:
converting the compensation voltage into the compensating current; and
adding the compensation current and the ripple current.

17. The method according to claim 16 further comprising:
amplifying the compensating current.

18. The method according to claim 16 further comprising:
eliminating a DC component of the compensation current.

19. The method according to claim 12 further comprising:
varying the compensation provided by said compensation current.

20. A switching converter comprising:
a switch;
a first filter; and
a circuit to inject a compensating current such that the AC component of a switching current issued from the switch and the compensating current are in opposite phase,
wherein the compensating current is elaborated from a signal at a node between the switch and the first filter.
